(19) United States
(12) Patent Application Publication
(10) Pub. No.: US 2010/0136434 A1
(43) Pub. Date: Jun. 3, 2010

(54) Electrolytic Copper Foil for Lithium Rechargeable Battery and Process for Producing the Copper Foil

(75) Inventor: Mikio Hanafusa, Ibaraki (JP)

Correspondence Address: HOWSON & HOWSON LLP, 501 OFFICE CENTER DRIVE, SUITE 210, FORT WASHINGTON, PA, 19034, US

(73) Assignee: NIPPON MINING & METALS CO., LTD., Tokyo (JP)

(21) Appl. No.: 12/596,454

(22) PCT Filed: Apr. 8, 2008
(86) PCT No.: PCT/JP2008/056915

§ 371 Date: Oct. 19, 2009

(30) Foreign Application Priority Data
Apr. 20, 2007 (JP) 2007-111266

(51) Int. Cl. H01M 4/66; C22F 1/08; C22C 9/00

(52) U.S. Cl. 429/245; 148/679; 148/432

(57) ABSTRACT

An electrolytic copper foil for a lithium rechargeable (secondary) battery, wherein the 0.2% proof stress is 18 to 25 kgf/mm² and the elongation rate is 10% or more; and a process for producing an electrolytic copper foil for a lithium rechargeable battery, wherein an electrolytic copper foil whose 0.2% proof stress is 18 to 25 kgf/mm² and elongation rate is 10% or more is manufactured by subjecting the electrolytic copper foil to an annealing treatment at a temperature within the range of 175° C. to 300° C. The present invention provides such an electrolytic copper foil used for a lithium rechargeable battery that has good proof stress and elongation rate and will not be easily broken due to electrode breakage caused by charge and discharge of the lithium rechargeable battery; and the invention also provides a process for producing such an electrolytic copper foil.

### TECHNICAL FIELD

The present invention relates to an electrolytic copper foil used for such a negative current collector for a lithium rechargeable (secondary) battery that will not be easily broken due to electrode breakage caused by charge and discharge of the lithium rechargeable battery; and the invention also relates to a process for producing such an electrolytic copper foil.

### BACKGROUND ART

Lithium rechargeable batteries are used in electronic devices such as cell-phones, video cameras, and personal computers. Along with downsizing of the electronic devices, downsizing and capacity increase of the lithium rechargeable batteries are progressing. Initial charging capacity and charge-discharge property are particularly important among properties required for the lithium rechargeable batteries.

In recent years, high-speed charge has been required for the lithium rechargeable batteries. However, as a result of manufacturing lithium rechargeable batteries that meet the demand for the high-speed charge, it is observed that the capacity starts to decrease earlier in charge-discharge cycles or the electrodes become broken.

As for the cause of degradation of the charge-discharge property as described above, it is assumed that adhesion between a copper foil and a negative-electrode material as well as impurities may have a causal influence on such degradation. For example, it is known that if several hundreds ppm of zinc is contained in order to prevent oxidation of an electrolytic copper foil, the charge-discharge property of the lithium rechargeable battery will degrade. Therefore, the content of an additive to prevent oxidation of the electrolytic copper foil is limited to a minimum amount. On the other hand, the problem of electrode breakage has not been solved yet.

When a lithium rechargeable battery is charged, lithium ions are taken into an electrode material; and the lithium ions are released when the lithium rechargeable battery is discharged. This means that the electrode material expands at the time of battery charge when the lithium ions are taken into the electrode material, and the electrode material returns to its original size at the time of battery discharge when the lithium ions are released. It is assumed that the copper foil supporting the electrode material expands or contracts following the expansion or contraction of the electrode material. As a result, the repetitive load will be imposed on the copper foil. The cause of the electrode breakage phenomenon has not been sufficiently clarified, but the above-described load on the copper foil is presumed to be the cause of the electrode breakage.

A suggested conventional technique relates to an electrolytic copper foil with a low rough surface, whose surface roughness is 2.0 μm or less and elongation rate at a temperature of 180° C. is 10.0% or more, and that is to be used for a printed-wiring board or a negative current collector for a rechargeable (secondary) battery (see Patent Document 1). However, this technique itself does not mention anything about the problem of electrode breakage or suggest any means for solving this problem. As a result, the same problem as that of the conventional art still exists.

### [Patent Document 1] Japanese Patent Laid-Open Publication No. 2004-263289

### DISCLOSURE OF THE INVENTION

The present invention provides such an electrolytic copper foil for a lithium rechargeable battery that has good proof stress and elongation rate and will not be easily broken due to electrode breakage caused by repeated charge and discharge of the lithium rechargeable battery; and the invention also provides a process for producing such an electrolytic copper foil.

As a result of thorough examinations to solve the above-described problem, the inventors found that such an electrolytic copper foil for a lithium rechargeable battery that has good proof stress and elongation rate and will not be easily broken can be obtained by subjecting the electrolytic copper foil to an annealing treatment at a specified temperature, and electrode breakage caused by repeated charge and discharge can be prevented in a negative current collector for the lithium rechargeable battery using the electrolytic copper foil. Structure requirement and properties of the electrolytic copper foil having the electrode breakage prevention effect are as described below.

Based on the above-described finding, the present invention provides:

1) A copper foil for a lithium rechargeable battery, whose 0.2% proof stress is 18 to 25 kgf/mm² and elongation rate is 10% or more.

The electrolytic copper foil having the effect of preventing electrode breakage needs to have sufficient proof stress as an indicator of resistance to breakage and be flexible for expansion and contraction. The requirements for the present invention satisfy these conditions.

2) It is more preferable that the copper foil for a lithium rechargeable battery according to paragraph 1) above has elongation rate of 10 to 19%.

The present invention also provides:

3) An electrolytic copper foil for a lithium rechargeable battery, wherein the foil thickness of the electrolytic copper foil is 9.5 to 12.5 μm. The above-mentioned thickness of the electrolytic copper foil is an optimum thickness for the use in a lithium rechargeable battery, and such thickness can be achieved according to this invention. It is possible to make adjustments, if necessary, to obtain a thickness thinner or thicker than the above-described range of thickness. The present invention does not limit the thickness of the electrolytic copper foil to the above-mentioned range of thickness, but includes the above-mentioned range of thickness.

Furthermore, the present invention provides:

4) The copper foil for a lithium rechargeable battery according to any one of paragraphs 1) to 3) above, wherein the surface roughness Rz of the copper foil is 1.0 to 2.0 μm. Large surface roughness is not favorable for prevention of breakage because it could easily cause generation of cracks. Therefore, it is desirable that the surface roughness Rz of the copper foil is 2.0 μm or less. If the surface roughness Rz of the copper foil is less than 1.0 μm, adhesion to a negative-electrode material tends to decrease. Therefore, it is more preferable that the surface roughness Rz is 1.0 μm or more.

Furthermore, the present invention provides:

5) The electrolytic copper foil for a lithium rechargeable battery according to any one of paragraphs 1) to 4) above, wherein a rust-proof chromium layer is provided on a surface of the electrolytic copper foil and a deposition amount of chromium in the rust-proof layer is 2.6 to 4.0 mg/m². It is desirable that the rust-proof chromium layer is formed to prevent surface oxidation of the electrolytic copper foil. However, there is a possibility that an excessive deposition of chromium in this rust-proof layer may degrade the charge-discharge property of the lithium battery. Therefore, an optimum deposition amount of chromium is 2.6 to 4.0 mg/m².
6) A process for producing an electrolytic copper foil for a lithium rechargeable battery, wherein an electrolytic copper foil whose 0.2% proof stress is 18 to 25 kgf/mm² and elongation rate is 10% or more is manufactured by subjecting the electrolytic copper foil to an annealing treatment at a temperature within the range of 175° C. to 300° C., is suggested. The electrolytic copper foil originally has the defect of low flexibility; however, the flexibility and proof stress can be improved by annealing the electrolytic copper foil. This is a favorable condition for the effect of preventing electrode breakage in a negative current collector of a lithium rechargeable battery.

### EFFECT OF THE INVENTION

Since an electrolytic copper foil according to the present invention used for a negative current collector of a lithium rechargeable battery has good proof stress and elongation rate, it will not be easily broken even after repeated charge and discharge of the battery and has the excellent effect of remarkably improving the charge-discharge cycle property.

### BRIEF DESCRIPTION OF THE DRAWINGS

FIG. 1 is a schematic diagram of an electrolytic copper foil manufacturing apparatus.

### BEST MODE FOR CARRYING OUT THE INVENTION

Generally speaking, an electrolytic copper foil is continuously manufactured by: using a rotating metal cathode drum whose surface is polished, and an insoluble metal anode (positive electrode) placed to surround roughly the lower half part of the cathode drum; electrodepositing copper onto the cathode drum by flowing copper electrolyte between the cathode drum and the anode and applying an electrical potential between them; and, when achieving a prescribed thickness, peeling the electrodeposited copper from the cathode drum.

The electrolytic copper foil obtained in this manner is generally called “raw copper foil,” which is subsequently subjected to some surface treatments and then used in, for example, a printed-wiring board.

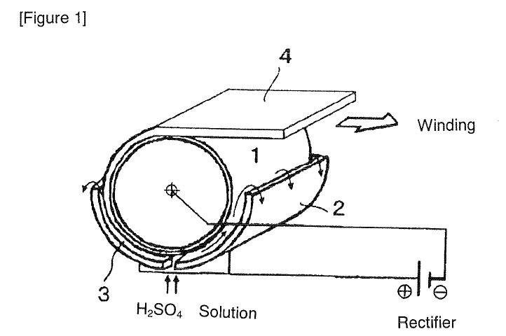

FIG. 1 shows a schematic view of an electrolytic copper foil manufacturing apparatus. This electrolytic copper foil apparatus is configured so that a cathode drum is set in an electrolytic bath which contains an electrolyte. This cathode drum 1 is designed to rotate while a part (roughly the lower half part) of the cathode drum 1 is immersed in the electrolyte.

An insoluble anode (positive electrode) 2 is placed to surround the outside surface of the lower half part of the cathode drum 1. There is a certain space 3 between the cathode drum 1 and the anode 2, and the electrolyte flows between them. Two anode plates are placed in the apparatus shown in FIG. 1.

The apparatus shown in FIG. 1 is configured so that the electrolyte is supplied from underneath, passes through the space 3 between the cathode drum 1 and the anode 2, overflows from the upper edges of the anode 2, and further circulates. A specified voltage can be maintained between the cathode drum 1 and the anode 2 via rectifier.

As the cathode drum 1 rotates, the thickness of the copper electrodeposited from the electrolyte increases; and when the thickness of the electrodeposited copper reaches a certain value or more, this raw copper foil 4 is peeled off and continuously wound up. The thickness of the raw copper foil manufactured in this manner is adjusted by the distance between the cathode drum 1 and the anode 2, a flow rate of the supplied electrolyte, or the quantity of supplied electricity.

Regarding the copper foil manufactured by the above-described electrolytic copper foil manufacturing apparatus, a surface of the copper foil in contact with the cathode drum becomes a mirror surface, while the other surface becomes a rough surface with asperity. Ordinary electrolysis has problems of a markedly uneven rough surface, a tendency of undercuts to be easily generated at the time of etching, and difficulty in making a fine pattern.

Also in the present invention, since such a markedly uneven surface may cause cracks, this is one of the conditions that should preferably be avoided. Thus, it is necessary to make the rough surface low-profile; however, there is no particular limitation on how to make the rough surface low-profile. In other words, all the known methods for making a rough surface low-profile can be used.

According to the present invention, the electrolytic copper foil obtained above is put into an annealing furnace; and after a vacuum is formed in the annealing furnace once and the annealing furnace is then filled with nitrogen gas, an annealing treatment is performed. It is desirable that the annealing treatment is performed at a temperature within the range of 175° C. to 300° C. If the annealing treatment is performed at a temperature higher than 350° C., the copper foil will be oxidized, which needs to be avoided. It should be understood that heating at a temperature higher than the above-mentioned temperature can be performed by preparing sufficient means for preventing oxidation.

On the other hand, if the annealing treatment is performed at a temperature lower than 170° C., residual stress existing in the electrolytic copper foil is high and proof stress of the copper foil is too large, thereby failing to achieve the object of the present invention. Therefore, the appropriate annealing temperature is within the range of 175° C. to 300° C. If the electrolytic copper foil is subjected to the annealing treatment at a temperature within the range of 175° C. to 300° C., a copper foil of comparatively large grain size is obtained. The copper foil whose grain size is large and which has few grain boundaries has the effect of preventing cracks which may cause electrode breakage; and therefore it can be said that the above-described condition is more favorable.

As described above, the electrolytic copper foil for a lithium rechargeable battery is require to have 0.2% proof stress of 18 to 25 kgf/mm² and elongation rate of 10% or more. If the 0.2% proof stress is less than 18 kgf/mm², the electrolytic copper lacks strength and it may cause crack generation. If the 0.2% proof stress exceeds 25 kgf/mm², flexibility is lost and it may cause crack generation, so this becomes a problem. The electrolytic copper foil having the effect of preventing electrode breakage is required to have sufficient proof stress, which is an indicator of resistance to breakage, and be flexible for expansion and contraction.

In that sense, the electrolytic copper foil is required to have elongation rate of 10% or more. Furthermore, the elongation rate of 10 to 19% is a favorable condition.

The present invention provides a copper foil for a lithium rechargeable battery on a preferable condition that surface roughness Rz of the electrolytic copper foil is 1.0 to 2.0 μm. The surface roughness of the electrolytic copper foil can be adjusted by an additive to the electrolyte, and known methods for adjusting the surface roughness can be arbitrarily used. Also, the surface roughness to be adjusted means roughness of both sides of the copper foil.

Large surface roughness is not favorable in terms of prevention of breakage. This is because large surface roughness may cause cracks. Therefore, it is desirable that the surface roughness Rz of the electrolytic copper foil is 2.0 μm or less. If the surface roughness Rz of the copper foil is less than 1.0 μm, adhesion to a negative-electrode material tends to decrease. Therefore, it is desirable that the surface roughness Rz is 1.0 μm or more.

However, if the risk of generation of some cracks can be ignored, it is possible to manufacture an electrolytic copper foil whose surface roughness is beyond or below the range mentioned above. The present invention specifies the optimum numerical conditions, and it should be realized that it is possible to manufacture an electrolytic copper foil that meets numerical conditions different from those mentioned above, as the need arises. The present invention includes all of these conditions.

The present invention provides an electrolytic copper foil having a rust-proof chromium layer whose chromium deposition amount is 2.6 to 4.0 mg/m² as a preferable aspect. This is to prevent surface oxidation of the electrolytic copper foil. However, there is a possibility that chromium which prevents oxidation of the electrolytic copper foil may also be involved, as in the case of zinc which has been conventionally used, in degradation of the charge-discharge property of the lithium battery. Therefore, it is necessary to keep the amount of chromium to the minimum. In other words, it is desirable that the chromium deposition amount should be decided in consideration of the above-described matter when forming the rust-proof chromium layer.

On the other hand, if the chromium deposition amount is less than 2.6 mg/m², the copper foil will be easily oxidized. Specifically speaking, if the copper foil is left in the atmosphere for a long time, the copper foil will be oxidized and its charge-discharge property tends to degrade. Therefore, the chromium deposition amount should preferably be 2.6 mg/m² or more in order to obtain the oxidation prevention effect by the rust-proof chromium layer. As a result, it can be said that the optimum chromium deposition amount is 2.6 to 4.0 mg/m².

However, the rust-proof chromium layer is applied if the surface oxidation tends to easily occur when handling the electrolytic copper foil. If the risk of the surface oxidation is low or can be ignored, it is not particularly indispensable. In other words, it should be realized that the rust-proof chromium layer may be used arbitrarily if required. The present invention includes all the above-described aspects.

Each of the followings; the electrolytic copper foil for a lithium rechargeable battery having 0.2% proof stress of 18 to 25 kgf/mm² and elongation rate of 10% or more, and the manufacturing method for obtaining such an electrolytic copper foil; is independent and the most important condition for the present invention. The present invention provides this electrolytic copper foil for a lithium rechargeable battery.

The present invention has been explained above by including the additional conditions. It should be clearly understood that these are additional and more favorable conditions for achieving the electrolytic copper foil for a lithium rechargeable battery according to the present invention.

### EXAMPLES

Characteristics of the present invention will be specifically explained below. Incidentally, the following explanation is given in order to facilitate understanding of the invention, and the invention will not be limited by this explanation. In other words, this invention includes variations, embodiments, and other examples based on the technical ideas of this invention.

### Examples 1 to 4

An electrolytic copper foil was manufactured using an apparatus, as shown in FIG. 1, capable of continuously manufacturing the electrolytic copper foil at a drum-type cathode used for commercial production. An electrolyte contained 85 g/L of copper, 75 g/L of sulfuric acid, 60 mg/L of chloride ions, 3-10 ppm of bis-(3-sulfopropyl)-disulfide sodium salt, and 2-20 ppm of nitride-containing organic compound. The liquid temperature of the electrolyte was 53° C., the linear velocity of the electrolyte was 1.0 m/min, and the current density was 50 A/dm². The foil thickness of the electrolytic copper foil was 9.5 to 12.5 μm.

The obtained electrolytic copper foil was subjected to a surface oxidation prevention treatment so that the chromium deposition amount should be within the range of 2.6 to 4.0 mg/m². As a result, a roll sample that was 400 mm wide and 1000 m long was manufactured.

After putting the roll sample manufactured above into an annealing furnace and forming a vacuum in the annealing furnace, the annealing furnace was filled with nitrogen gas and the annealing treatment was performed.

In Example 1, the annealing treatment was performed by increasing the temperature from room temperature to 175° C. in one hour and keeping the temperature of 175° C. for 10 hours. A roll temperature reached 175° C. after 9 hours because of the heat capacity of the roll.

In Example 2, the annealing treatment was performed by increasing the temperature from room temperature to 225° C. in one hour and keeping the temperature of 225° C. for 10 hours.

In Example 3, the annealing treatment was performed by increasing the temperature from room temperature to 275° C. in one hour and keeping the temperature of 275° C. for 10 hours.

In Example 4, the annealing treatment was performed by increasing the temperature from room temperature to 300° C. in one hour and keeping the temperature of 300° C. for 10 hours.

### (Tension Strength Test)

The heat-treated copper foil was cut into a piece which was 150 mm long and 12.7 mm wide. Then, a tensile test was performed at a distance between chucks of 50 mm and a tensile rate of 50 mm/min. Table 1 shows 0.2% proof stress and elongation rate based on the obtained stress-strain curve.

The 0.2% proof stress in each of Examples 1 to 4 was good, which was within the range of 18 to 25 kgf/mm². The elongation rate in each of Examples 1 to 4 was also good, which was 10% or more.

TABLE 1

| | 0.2% Proof | Elongation | Surface | |
|---|---|---|---|---|
| | stress | Rate | Roughness | |
| | (kgf/mm²) | (%) | (Rz) | Crack Generation |
| Example 1 | 25.0 | 12.2 | 1.25 | None |
| Example 2 | 23.2 | 16.6 | 1.23 | None |
| Example 3 | 20.3 | 18.2 | 1.28 | None |
| Example 4 | 18.1 | 19.0 | 1.19 | None |
| Comparative | 29.7 | 11.9 | 1.27 | Cracks generated |
| Example 1 | | | | |
| Comparative | 16.6 | 19.3 | 1.23 | Cracks generated |
| Example 2 | | | | |
| Comparative | 32.8 | 11.4 | 1.30 | Large cracks |
| Example 3 | | | | generated |

### (Charge-Discharge Test)

A charge-discharge test was performed by manufacturing a battery under the following conditions and repeating charge and discharge a specified number of times. Then the surface of the copper foil was checked for crack generation and the size of cracks, and the results of observation were also arranged in Table 1. Materials for the positive electrode and the negative electrode were as follows:

(Positive-Electrode Materials)

| | | |
|---|---|---|
| LiCoO₂ | 85 | wt % |
| Conductive material (acetylene black) | 8 | wt % |
| Binder (polyvinylidene fluoride) | 7 | wt % |

(Negative-Electrode Materials)

| | | |
|---|---|---|
| Negative-electrode material (graphite or carbon material) | 95 to 98 | wt % |
| Binder (polyvinylidene fluoride) | 5 to 2 | wt % |

N-methylpyrrolidone was added to the above-listed materials to produce slurry, which was then applied to an aluminum foil as a positive electrode and to a copper foil as a negative electrode. After the solvent was made to evaporate, the obtained materials were rolled out and subjected to slitting to a certain size to form the electrodes.

Three elements, i.e. the positive electrode, a separator (a porous polyethylene film that has been subjected to a hydrophilic treatment), and the negative electrode, were wounded together and put into a container, into which the electrolyte was poured and which was then sealed, thereby obtaining a battery. Regarding the battery standard, a common cylindrical 18650 type was used. As for the type of the electrolyte, EC (ethylene carbonate) containing 1M LiPF₆ and DMC (dimethyl carbonate) were used in a ratio of 1:1 (volume ratio).

The battery was charged in a CCCV (constant-current and constant-voltage) mode at a charging voltage of 4.3 V and a charging current of 0.2 C (corresponding to a current for charging for 5 hours). The battery was discharged at a CC (constant-current) mode at a discharging voltage of 3.0 V and a discharging current of 0.5 C (corresponding to a current for discharging for 2 hours).

As a result of observation of the appearance of the copper foils after charge and discharge in Examples 1 to 4 as shown in Table 1, all of them had no cracks and showed good appearance.

### Comparative Examples 1 to 3

The copper foil was treated in the same manner as in examples, except the conditions for the annealing treatment. In Comparative Example 1, the annealing treatment was performed by increasing the temperature from room temperature to 100° C. in one hour and keeping the temperature of 100° C. for 10 hours.

In Comparative Example 2, the annealing treatment was performed by increasing the temperature from room temperature to 350° C. in one hour and keeping the temperature of 350° C. for 10 hours.

In Comparative Example 3, the annealing treatment was not performed.

### (Tensile Strength Test)

The heat-treated copper foil was cut into a piece which was 150 mm long and 12.7 mm wide. Then, a tensile test was performed at a distance between chucks of 50 mm and a tensile rate of 50 mm/min. Table 1 shows 0.2% proof stress and elongation rate based on the obtained stress-strain curve.

In Comparative Example 1, the 0.2% proof stress was 29.7 kgf/mm² which was large and was a bad result that did not satisfy the condition specified for the present invention.

In Comparative Example 2, the elongation rate was large, but the 0.2% proof stress was 16.6 kgf/mm² which was small and was a bad result that did not satisfy the condition specified for the present invention.

In Comparative Example 3, the 0.2% proof stress was 32.8 kgf/mm² which was extremely large and was a bad result that did not satisfy the condition specified for the present invention.

### (Charge-Discharge Test in Comparative Examples)

The charge-discharge test was performed by manufacturing a battery under the same conditions as those for Examples described above and repeating charge and discharge a specified number of times. Then the surface of the copper foil was checked for crack generation and the size of cracks. FIG. 1 shows the result of the charge-discharge test.

In Comparative Example 1 and Comparative Example 2, slightly large cracks were observed. In Comparative Example 3, large cracks were observed, which was a bad result.

As is apparent from the above results, no cracks were generated after the charge-discharge test on the electrolytic copper foil whose 0.2% proof stress was 18 to 25 kgf/mm². In this case, the elongation rate tends to decrease with an increase of the proof stress; however, if the 0.2% proof stress is within the range of 18 to 25 kgf/mm², the elongation rate is 10% or more and cracks will not be generated.

Although there is not so obvious contrast, if the surface roughness (Rz) is less than 1.0 μm, the adhesion of the copper foil to the negative-electrode material is weak and the copper foil will come off as a result of the charge-discharge test. If the surface roughness Rz is larger than 2.0 μm, a difference in the roughness between the front side and the back side of the copper foil becomes large and it is difficult to apply the negative-electrode material uniformly on both sides of the copper foil. Therefore, the electrolytic copper foil with the surface roughness Rz within the range of 1.0 to 2.0 μm exhibits particularly good property.

The present invention adjusts the 0.2% proof stress to 18 to 25 kgf/mm² and the elongation rate to 10% or more by subjecting the electrolytic copper foil to the annealing treatment at a temperature within the range of 175° C. to 300° C. In this case, the grain size increases from fine particles to coarse particles, and it was confirmed that such grain size increase is a favorable condition and has the optimum crack prevention effect.

### INDUSTRIAL APPLICABILITY

The present invention provides an electrolytic copper foil having good proof stress and elongation rate. A lithium rechargeable battery using the electrolytic copper foil as a negative current collector shows the excellent effect of having good charge-discharge cycle property. Therefore, the electrolytic copper foil of this invention is ideal for use in a lithium rechargeable battery because the electrolytic copper foil has good proof stress and elongation rate and will not be easily be broken.

1. An electrolytic copper foil for a lithium rechargeable battery, wherein its 0.2% proof stress is 18 to 25 kgf/mm² and its elongation rate is 12.2% or more.

2. The electrolytic copper foil for a lithium rechargeable battery according to claim 1, wherein its elongation rate is 12.2 to 19%.

3. The electrolytic copper foil for a lithium rechargeable battery according to claim 2, wherein the foil thickness of the electrolytic copper foil is 9.5 to 12.5 μm.

4. The electrolytic copper foil for a lithium rechargeable battery according to claim 3, wherein the surface roughness Rz of the electrolytic copper foil is 1.0 to 2.0 μm.

5. The electrolytic copper foil for a lithium rechargeable battery according to claim 4, wherein a rust-proof chromium layer is provided on a surface of the electrolytic copper foil and a deposition amount of chromium in the rust-proof layer is 2.6 to 4.0 mg/m².

6. A process for producing an electrolytic copper foil for a lithium rechargeable battery, wherein an electrolytic copper foil whose 0.2% proof stress is 18 to 25 kgf/mm² and elongation rate is 12.2% or more is manufactured by subjecting the electrolytic copper foil to an annealing treatment at a temperature within the range of 175° C. to 300° C.

7. The process for producing the electrolytic copper foil for a lithium rechargeable battery according to claim 6, wherein elongation rate of the electrolytic copper foil is 12.2 to 19%.

8. The process for producing the electrolytic copper foil for a lithium rechargeable battery according to claim 7, wherein the foil thickness of the electrolytic copper foil is 9.5 to 12.5 μm.

9. The process for producing the electrolytic copper foil for a lithium rechargeable battery according to claim 6, wherein the foil thickness of the electrolytic copper foil is 9.5 to 12.5 μm.

10. The electrolytic copper foil for a lithium rechargeable battery according to claim 1, wherein the foil thickness of the electrolytic copper foil is 9.5 to 12.5 μm.

11. The electrolytic copper foil for a lithium rechargeable battery according to claim 10, wherein the surface roughness Rz of the electrolytic copper foil is 1.0 to 2.0 μm.

12. The electrolytic copper foil for a lithium rechargeable battery according to claim 11, wherein a rust-proof chromium layer is provided on a surface of the electrolytic copper foil and a deposition amount of chromium in the rust-proof layer is 2.6 to 4.0 mg/m².

13. The electrolytic copper foil for a lithium rechargeable battery according to claim 1, wherein the surface roughness Rz of the electrolytic copper foil is 1.0 to 2.0 μm.

14. The electrolytic copper foil for a lithium rechargeable battery according to claim 13, wherein a rust-proof chromium layer is provided on a surface of the electrolytic copper foil and a deposition amount of chromium in the rust-proof layer is 2.6 to 4.0 mg/m².

15. The electrolytic copper foil for a lithium rechargeable battery according to claim 1, wherein a rust-proof chromium layer is provided on a surface of the electrolytic copper foil and a deposition amount of chromium in the rust-proof layer is 2.6 to 4.0 mg/m².
